(19) United States
(12) Patent Application Publication
(10) Pub. No.: US 2014/0277803 A1
(43) Pub. Date: Sep. 18, 2014

(54) CENTRAL CONTROL FRAME IN VENDING MACHINE WITH POWER SUPPLY PROTECTOR

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHIN-WEN YEH, New Taipei (TW); YANG XIAO, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/051,369

(22) Filed: Oct. 10, 2013

(30) Foreign Application Priority Data
Mar. 18, 2013 (CN) 2013100849451

(51) Int. Cl. G05F 1/66

(52) U.S. Cl. CPC G05F 1/66
USPC 700/292

(57) ABSTRACT

A central control frame includes a main frame, an installation frame slidably mounted in the main frame, and a power supply protector. The installation frame includes a first bracket and a secured bracket. A computer is secured to the first bracket. A power supply protector is secured to the second bracket. An input port of the power supply protector connects to an AC power supply, an output port of the power supply protector connects to the computer, and the power supply protector provides power to the computer when the AC power supply is cut off suddenly, preventing files in the computer from being damaged or lost.

### BACKGROUND

1. Technical Field

The present disclosure relates to vending machines, and particularly to a central control frame in a vending machine with a power supply protector.

2. Description of Related Art

In many vending machines, a computer is secured to a central control frame and used for displaying product messages, such as type and price, and may supply extra functions, such as fun games. Generally, the computer is connected to an adapter, and then the adapter is connected to an AC power supply. When the vending machine is stopped or the power supply is powered off suddenly, the computer will be powered off immediately, which may cause some files stored in the computer to be damaged or lost. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a central control frame of a vending machine.

FIG. 2 is an isometric view of an installation frame of the central control frame of FIG. 1, and viewed from a different aspect.

FIG. 3 is an exploded, isometric view of the installation frame of FIG. 2.

FIG. 4 is an enlarged view of a circled portion IV of FIG. 3.

FIG. 5 is an assembled, isometric view of the central control frame of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows one embodiment of a central control frame 100 of a vending machine. The central control frame 100 is used for installing a computer 10 and includes a main frame 20 and an installation frame 30 slidably mounted in the main frame 20. In one embodiment, the computer 10 is an industrial computer.

The main frame 20 includes a top plate 21, a bottom plate 22, and a front plate 23. In one embodiment, the top plate 21 is substantially parallel to the bottom plate 22, and the front plate 23 is substantially perpendicular to the top plate 21 and the bottom plate 22.

Two beams 26 are connected between the top plate 21 and the bottom plate 22. Two first sliding rails 231 are secured to the front plate 23. An extending direction of each first sliding rail 231 is substantially parallel to the bottom plate 22. Two second sliding rails 261, corresponding to the two first sliding rails 231 each, are secured between the two beams 26.

FIGS. 2-4 show that the installation frame 30 includes a mounting plate 31, an installation plate 32, a first bracket 33, a second bracket 35, and a third bracket 36. The mounting plate 31 is substantially parallel to the installation plate 32. The computer 10 is secured to the first bracket 33 by screws or other securing methods.

A first sliding plate 331 is secured to each of opposite sides of the first bracket 33. The first sliding plate 331 defines a first sliding slot 332.

The central control frame 100 further includes a power supply protector 60. A top surface of the power supply protector 60 defines two first locking holes 61. A side surface of the power supply protector 60 defines two second locking holes 63. The power supply protector 60 is secured to the installation frame 30 by a mounting member 70 and an installation member 80. The mounting member 70 includes a first mounting piece 71 and a second mounting piece 72 extending perpendicularly from the first mounting piece 71. The first mounting piece 71 defines two first mounting holes 711. The second mounting piece 72 defines two second mounting holes 721. The first mounting piece 71 is secured to the mounting plate 31. The second mounting plate 72 is secured to the top surface of the power supply protector 60. In one embodiment, the power supply protector 60 is a chargeable power supply.

The installation member 80 includes a first installation piece 81 and two second installation pieces 82 extending from opposite side edges of the first installation piece 81. The first installation piece 81 defines two first installation holes 811. The second installation piece 82 defines a second installation hole 821. The first installation pieces 81 is secured to the side surface of the power supply protector 60 with the first installation hole 811 aligned with the second locking hole 63. The second installation piece 82 is secured to the sidewall 351 with the second installation hole 821 aligned with the locking hole 3511.

The third bracket 36 is used for securing a power strip 361 and a plurality of adapters 363. The power strip 361 connects to an AC power supply. An input port of the power supply protector 60 is inserted in the power strip 361 to connect to the AC power supply. The AC power supply charges the power supply protector 60. An output port of the power supply protector 60 is connected to the computer 10.

Each of the first bracket 33, the second bracket 35, and the third bracket 36 is secured to the mounting plate 31 and the installation plate 32.

FIG. 5 shows that, in assembly of the installation frame 30 to the main frame 20, the installation frame 30 is moved to be adjacent to the main frame 20, with each of the first sliding slot 332 and the second sliding slot 353 aligned with one of the first sliding rails 231 and one of second sliding rails 261. The installation frame 30 is slid into the main frame 20 and secured to the main frame 20.

In use, when the AC power supply is cut off and the vending machine is closed suddenly, the power supply protector 60 charges the computer 10, providing a buffer time for the computer 10 to store files to prevent the files from being damaged or lost.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A central control frame, comprising:
a main frame;
an installation frame slidably mounted in the main frame and comprising a first bracket and a second bracket;
a computer secured to the first bracket; and
a power supply protector secured to the second bracket;
wherein an input port of the power supply protector connects to an AC power supply, an output port of the power supply protector connects to the computer, and the power supply protector is configured to provide power to the computer when the AC power supply is cut off.

2. The central control frame of claim 1, wherein the installation frame further comprises a mounting plate and an installation plate, and the first bracket and the second bracket are secured between the mounting plate and the installation plate.

3. The central control frame of claim 2, further comprising a mounting member and an installation member, wherein the mounting member secures the power supply protector to the mounting plate, and the installation member secures the power supply protector to the installation plate.

4. The central control frame of claim 3, wherein the mounting member comprises a first mounting piece and a second mounting piece extending perpendicularly from the first mounting piece, the first mounting piece is secured to the mounting plate, and the second mounting piece is secured to a top surface of the power supply protector.

5. The central control frame of claim 3, wherein the installation member comprises a first installation piece and a second installation piece, the first installation piece is secured to a side surface of the power supply protector, and the second installation piece is secured to the second bracket.

6. The central control frame of claim 1, wherein the main frame comprises a first sliding rail; the first bracket comprise a first sliding plate, and the first sliding plate defines a first sliding slot; and the first sliding rail is slidably received in the first sliding slot.

7. The central control frame of claim 5, wherein the main frame further comprises a second sliding rail; the second bracket comprises a sidewall and a second sliding plate secured to the sidewall, and the second sliding plate defines a second sliding slot; and the second sliding rail is slidably received in the second sliding slot.

8. The central control frame of claim 2, wherein the installation frame further comprises a third bracket located between the first bracket and the second bracket; the third bracket is secured between the mounting plate and the installation plate; the third bracket secures a power strip connecting the AC power supply; and the input port of the power supply protector connects to the power strip.

9. The central control frame of claim 8, wherein the third bracket further secures an adapter, and the second bracket is configured for securing a plurality of spare parts.

10. The central control frame of claim 1, wherein the power supply protector is a chargeable power supply.

11. A central control frame, comprising:
a main frame;
an installation frame slidably mounted in the main frame and comprising a first bracket, a second bracket, and a third bracket located between the first bracket and the second bracket;
a computer secured to the first bracket; and
a power supply protector secured to the second bracket;
wherein the third bracket secures a power strip connecting an AC power supply; an input port of the power supply protector connects to the power strip, an output port of the power supply protector connects to the computer, and the power supply protector provides power to the computer when the AC power supply is cut off.

12. The central control frame of claim 11, wherein the installation frame further comprises a mounting plate and an installation plate, and the first bracket and the second bracket are secured between the mounting plate and the installation plate.

13. The central control frame of claim 12, further comprising a mounting member and an installation member, wherein the mounting member secures the power supply protector to the mounting plate, and the installation member secures the power supply protector to the installation plate.

14. The central control frame of claim 13, wherein the mounting member comprises a first mounting piece and a second mounting piece extending perpendicularly from the first mounting piece, the first mounting piece is secured to the mounting plate, and the second mounting piece is secured to a top surface of the power supply protector.

15. The central control frame of claim 13, wherein the installation member comprises a first installation piece and a second installation piece, the first installation piece is secured to a side surface of the power supply protector, and the second installation piece is secured to the second bracket.

16. The central control frame of claim 11, wherein the main frame comprises a first sliding rail; the first bracket comprise a first sliding plate, and the first sliding plate defines a first sliding slot; and the first sliding rail is slidably received in the first sliding slot.

17. The central control frame of claim 15, wherein the main frame further comprises a second sliding rail; the second bracket comprises a sidewall and a second sliding plate secured to the sidewall, and the second sliding plate defines a second sliding slot; and the second sliding rail is slidably received in the second sliding slot.

18. The central control frame of claim 12, wherein the third bracket is secured between the mounting plate and the installation plate.

19. The central control frame of claim 11, wherein the third bracket further secures an adapter, and the second bracket is configured for securing a plurality of spare parts.

20. The central control frame of claim 11, wherein the power supply protector is a chargeable power supply.
